(19) United States
(12) Patent Application Publication
(10) Pub. No.: US 2007/0168574 A1
(43) Pub. Date: Jul. 19, 2007

(54) System and method for securing access to general purpose input/output ports in a computer system

(75) Inventors: Ricardo L. Martinez, Austin, TX (US); Jonathan T. Stern, Round Rock, TX (US); Charles M. Ueltschey III, Austin, TX (US)

Correspondence Address: Roger Fulghum;Baker Botts L.L.P., One Shell Plaza, 910 Louisiana Street, Houston, TX, 77002-4995, US

(73) Assignee: DELL PRODUCTS L.P.

(21) Appl. No.: 11/237,397

(22) Filed: Sep. 28, 2005

(51) Int. Cl. G06F 3/00

(52) U.S. Cl. 710/15

(57) ABSTRACT

A system and method is disclosed for managing the access to GPIO ports that are coupled to input pins of devices in the computer system. Access commands directed to a GPIO port are monitored. When an access command is detected, an interrupt is issued and an interrupt handler determines if the access command is authorized. If the command is authorized, the interrupt handler completes the access command and returns control to the software program that issued the access command. If the command is not authorized, the command is prevented from reaching the GPIO and the access attempt is logged. The GPIO ports that are monitored may be those GPIO ports that are coupled to an input or enable pin of a sensitive hardware component within the computer system.

### TECHNICAL FIELD

The present disclosure relates generally to computer systems and information handling systems, and, more particularly, to a system and method for securing access to general purpose input/output ports in a computer system.

### BACKGROUND

As the value and use of information continues to increase, individuals and businesses seek additional ways to process and store information. One option available to these users is an information handling system. An information handling system generally processes, compiles, stores, and/or communicates information or data for business, personal, or other purposes thereby allowing users to take advantage of the value of the information. Because technology and information handling needs and requirements vary between different users or applications, information handling systems may vary with respect to the type of information handled; the methods for handling the information; the methods for processing, storing or communicating the information; the amount of information processed, stored, or communicated; and the speed and efficiency with which the information is processed, stored, or communicated. The variations in information handling systems allow for information handling systems to be general or configured for a specific user or specific use such as financial transaction processing, airline reservations, enterprise data storage, or global communications. In addition, information handling systems may include or comprise a variety of hardware and software components that may be configured to process, store, and communicate information and may include one or more computer systems, data storage systems, and networking systems.

A computer system may include a number of general purpose input/output (GPIO) ports. GPIO ports often serve as an interface between hardware and software functions and components within a computer system. GPIO ports may be arranged as a group or block of single bit ports. A component of the computer system can write to any GPIO port within this block and another component of the hardware system can read from any of the GPIO ports within this block. GPIO ports are inherently unsecure, however, due to the ease with which components of the computer system can access the GPIO ports. A malicious software program can execute in a manner that causes a hardware component to write to one or more of the GPIO ports. If one of these GPIO ports is coupled to the enable pin of Trusted Platform Module (TPM) security chip, the resetting of a single GPIO port could in turn disable the function of the TPM chip of the computer system, thereby compromising the security of the entire computer system. Similarly, other components of the computer system may be coupled through an enable pin of the component to an easily accessible GPIO port. If an unauthorized program writes to the GPIO port, the component could be disabled and the function of the computer system may be impaired.

### SUMMARY

In accordance with the present disclosure, a system and method is disclosed for managing the access to GPIO ports that are coupled to input pins of devices in the computer system. Access commands directed to a GPIO port are monitored. When an access command is detected, an interrupt is issued and an interrupt handler determines if the access command is authorized. If the command is authorized, the interrupt handler completes the access command and returns control to the software program that issued the access command. If the command is not authorized, the command is prevented from reaching the GPIO and the access attempt is logged. The GPIO ports that are monitored may be those GPIO ports that are coupled to an input or enable pin of a sensitive hardware component within the computer system.

The system and method disclosed herein is technically advantageous because it operates to prevent access by unauthorized software agents to certain GPIO pins of the computer system. Use of the disclosed system and method prevents malicious software code from resetting the enable pin of hardware components of the computer system, including those hardware components, such as a TPM device, that are responsible for managing security functions within the hardware system. Another technical advantage of the system and method disclosed herein is that it is not limited in its implementation to GPIOs that are located in only one location in the computer system. So long as data access commands to a GPIO can be accessed and trapped, the system and method can be used herein to monitor any GPIO in the computer system. Because many GPIOs within the computer system can be monitored in this fashion, the device coupled to these GPIOs can likewise be managed to prevent unauthorized access to these devices. Other technical advantages will be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a diagram of a computer system;

FIG. 2 is a diagram of a computer system having a second configuration; and

FIG. 3 is a flow diagram of a method for managing access commands directed to a GPIO port.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communication with external devices as well as various input and output (I/O) devices, such as a keyboard, a mouse, and a video display. The information handling system may also include one or more buses operable to transmit communications between the various hardware components.

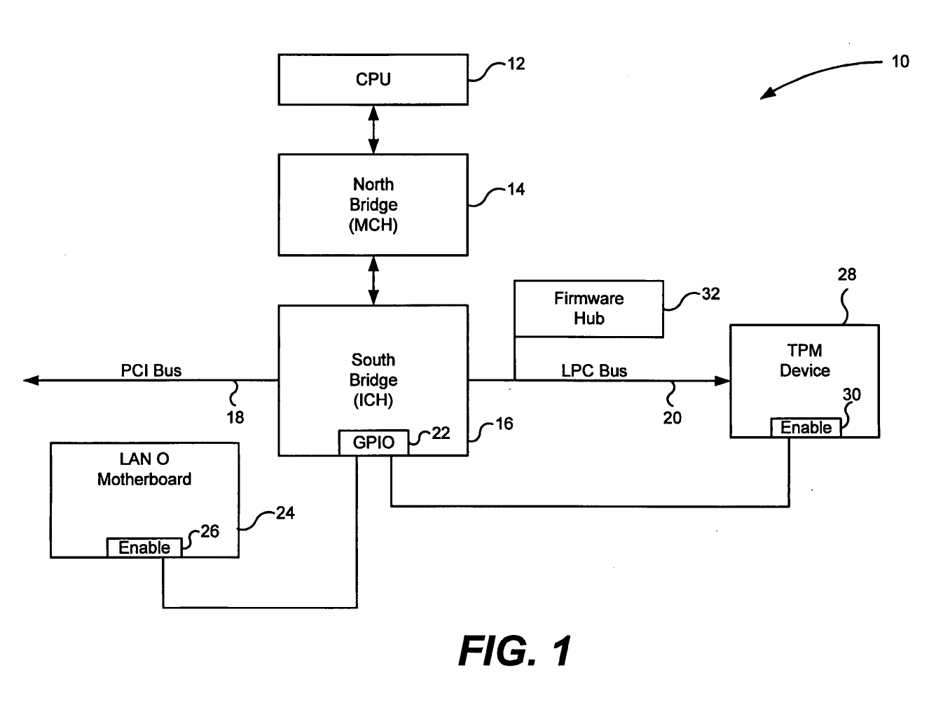

FIG. 1 is a diagram of a computer system, which is indicated generally at 10. Computer system 10 includes a CPU 12, which is coupled to a north bridge 14. In some architectural configurations, north bridge 14 is referred to as a memory controller hub (MCH) and may be coupled to system memory and a graphics controller (not shown in FIG. 1). North bridge 14 is coupled to a south bridge 16, which is sometimes referred to in other architectural configurations as an I/O controller hub (ICH). South bridge 16 is coupled to a Peripheral Component Interconnect (PCI) bus 18 and a low pin count (LPC) bus 20 PCI bus 18 may be coupled to one or more PCI devices or slots for receiving PCI add-in cards. Firmware hub 32 is coupled to LPC bus 20, and LPC bus 20 terminates in a Trusted Platform Module (TPM) device. A TPM device includes a controller and software for managing the security functions of the computer system. One of the functions of the TPM device is the management of encryption keys for software programs and stores of data.

A GPIO port is an embedded port within a computer system that can be read from or written to. A GPIO port may be a single bit port and is typically included with a device of the computer system. GPIO ports may be arranged into a set of accessible GPIO ports. South bridge 16 includes a set of GPIO ports 22. One of those GPIO ports is coupled to the enable pin 26 of a LAN-on-motherboard (LOM) device 24. An LOM device is a device on the motherboard of a computer system that manages network connections to the computer system. Another GPIO port of the set of GPIO ports 22 is coupled to the enable pin of TPM device 28. In operation, the logic level of the of the GPIO port that is coupled to the LOM device or the TPM device can be set to enable or disable the LOM device or the TPM device. Thus, by setting or resetting the GPIO port that coupled to the TPM module 24, the TPM device 24 can be toggled disabled or enabled, depending on the logic level of the GPIO port. Similarly, the LOM device can be toggled on and off by setting and resetting the GPIO port coupled to the enable pin on the LOM device. Thus, the ability to enable or disable each of the TPM device and the LOM device is managed by writing to the applicable GPIO port 22 in south bridge 16.

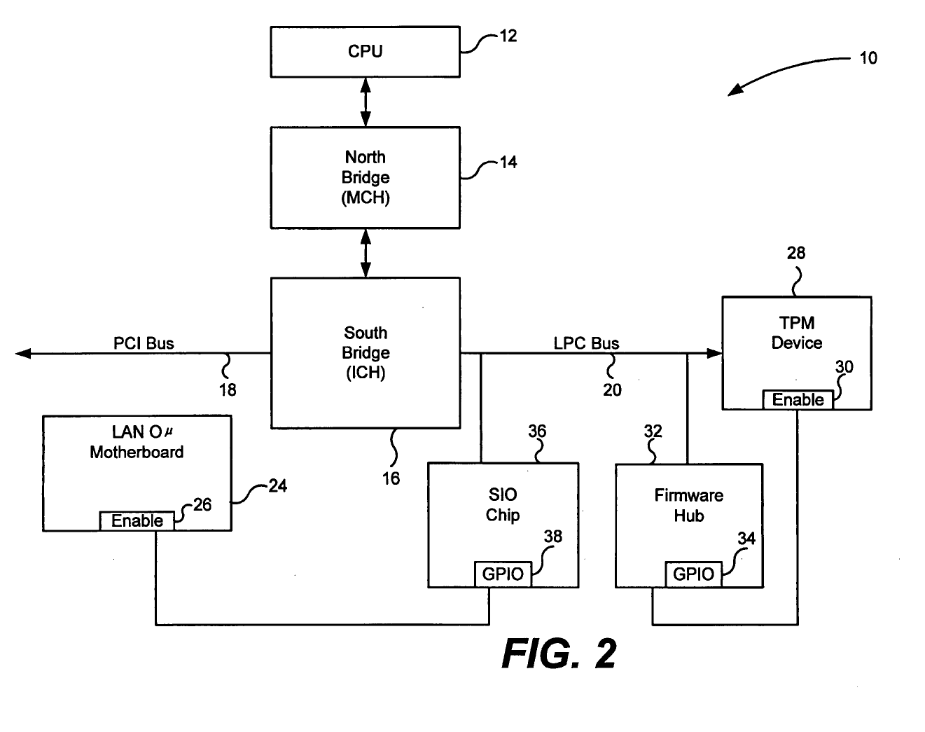

Shown in FIG. 2 is a variation of the architecture of the computer system shown in FIG. 1. Like the architecture of the computer system of FIG. 1, the computer system architecture of FIG. 2 includes a CPU 12, a north bridge 14, and a south bridge 16. In the example of FIG. 2, a Super 1(0 (SIO) chip 36 is coupled to LPC bus 20. Each of the SIO chip 36 and the firmware hub 32 includes a set of GPIO ports. GPIO ports 38 are included in SIO chip 36, and GPIO ports 34 are included in firmware hub 32. A GPIO port of SIO chip 36 is coupled to the enable pin 26 of LOM device 34, and a GPIO port of firmware hub 32 is coupled to the enable pin 30 of TPM device 30. Thus, a GPIO port in the SIO chip 36 can be set to enable or disable LOM device 24, and a GPIO port in firmware hub 34 can be set to enable or disable TPM device 28. FIG. 1 and FIG. 2 demonstrates that GPIO ports can be included in or more of several hardware devices of the computer system, including the south bridge and other discrete hardware components of the computer system. By connecting a GPIO port to an enable pin of a component, the enable status of that component is controlled through the attached GPIO port and the hardware component that includes the GPIO port.

In operation, the method of the present disclosure involves the identification of write commands or read commands directed to the GPIO port coupled to an enable pin of a component of the computer system. With reference to FIG. 1, the method of the present invention involves the identification of write commands and read commands to the GPIO port 22 that is coupled to enable pin 26 of the TPM module 24, or the identification of write commands and read commands to the GPIO port 22 that is coupled to enable pin 26 on of LOM device 24. With reference to FIG. 2, the method involves the identification of write commands or read commands to the GPIO port 38 that is coupled to the enable pin 26 of LOM device 24. Also, with reference to FIG. 2, the method involves the identification of write commands or read commands to the GPIO port 34 that is coupled to enable pin 30 of TPM device 28.

A port trap logic in south bridge 16 is configured to identify access commands to the GPIO port. Because the port trap logic is located in the computer system between CPU 12 and each of the GPIO ports, the port trap logic can monitor attempts to write to or read from any of the GPIO ports. When an access command is directed to the GPIO port, the port logic initiates a system management interrupt (SMI). During the interrupt, the interrupt service routine assigned to handle the SMI determines if the software that is attempting to access the GPIO port is authorized to access the GPIO port. If the accessing software is authorized to access the GPIO port, the interrupt service routine completes the access command. The interrupt service routine writes the data or returns the result to the software program that initiated the attempt to read from the GPIO port. If the accessing software is not authorized to access the GPIO port, the access command is denied and a log of the unauthorized access attempt is recorded in system memory or a storage location in the computer system. Although the port trap logic has been described as existing in the south bridge, the port trap logic could also exist in the north bridge. A port trap logic of the north bridge would likewise be able to monitor access commands to GPIO ports in the computer system and issue a system management interrupt.

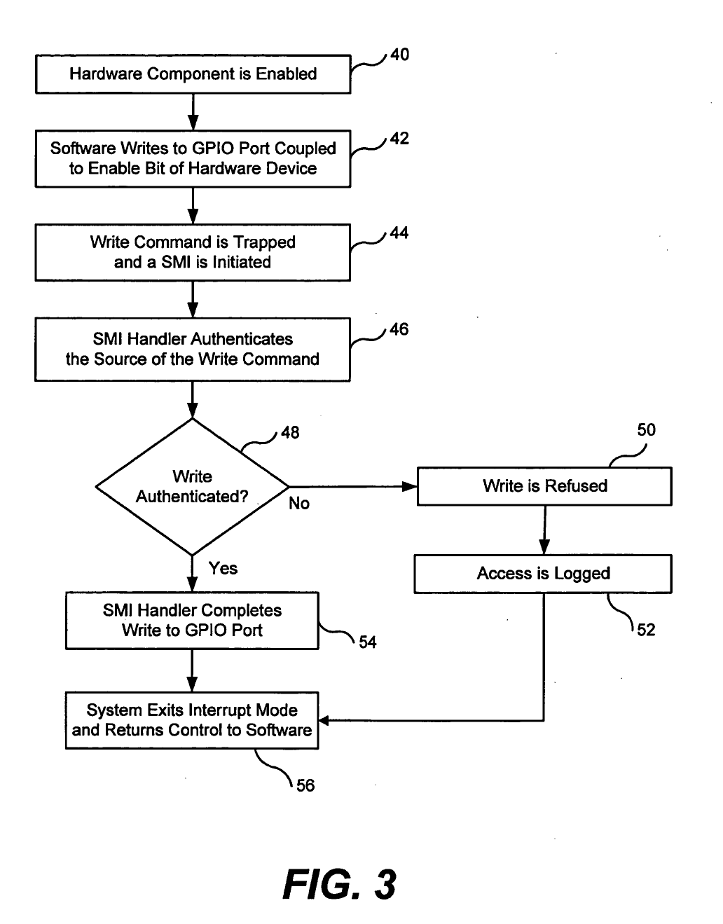

Shown in FIG. 3 is a flow diagram of a method for managing access commands directed to a GPIO port. In this example, the GPIO port is coupled to an enable pin of a device of the computer system. Because of the direct coupling of the GPIO port and the enable pin of the device, the toggling of the GPIO port also causes the device to toggle on and off. At step 40, the hardware component at issue is enabled. At step 42, a software program in the computer system attempts to write to the GPIO port that is coupled to the enable pin of the device. At step 44, the write command is recognized by the trap logic. Once a write command is recognized by the trap logic, the write command is trapped and a SMI is initiated. As described, the trap logic may reside in the north bridge or the south bridge of the computer system. At step 46, the SMI handler or interrupt service routine authenticates the software that issued the data access command. The software authentication process may involve reading or confirming a token in the software or comparing some other identifier of the software to a table of software that is approved to access the GPIO port. The software authentication process may also distinguish between write commands and read commands. Because write commands may change the content of the GPIO port, write commands may be subject to greater scrutiny during the authentication step. In some configurations, the trap logic may only trap and initiate a system management interrupt on the recognition of a write command.

If it is determined that the software does not have the right to write to or read from the GPIO port (step 48), the data access command is refused at step 50. The unauthorized data access command is logged to system memory or another storage location at step 52. The computer system next exits the interrupt mode and returns control to the software program that issued the unauthorized access command. If it is determined that the software program does have the right to write to or read from the GPIO port, the SMI handler or interrupt service routine completes the access command at step 54. The SMI handler completes the write command or the read command in a manner that is transparent to the software program that initiated the data access command directed to the GPIO port. Following the completion of the data access command by the SMI handler, the computer system exits interrupt mode and returns control to the software program that issued the access command (step 56). Following this methodology, in the case of write commands, only a limited set of authorized software program are allowed complete a write command to a GPIO port that is coupled to the enable pin of a device of the computer system.

The system and method disclosed herein provides a technique for monitoring and preventing unauthorized access to the GPIO ports that control the enabling and disabling of certain components of the computer system. The system and method disclosed herein prevents a malicious or otherwise unauthorized computer program from toggling a GPIO port to cause a device of the computer system, including the TPM device, to be disabled. It should also be recognized that the system and method disclosed herein is not limited in its application to the precise computer architecture shown in FIG. 1 and FIG. 2. Rather, the system and method disclosed herein may be employed in any computer system in which GPIO ports of a hardware device are coupled to the enable pin of the same or another hardware device. Similarly, the system and method of this disclosure is not limited in its application to the GPIO ports coupled to the enable pin of certain devices. Rather, the system and method can be applied in any environment in which a GPIO port is coupled to a pin or other input of a device, regardless of the function of the pin or input of the device. Although the present disclosure has been described in detail, it should be understood that various changes, substitutions, and alterations can be made hereto without departing from the spirit and the scope of the invention as defined by the appended claims.

What is claimed is:

1. A method for managing access to a GPIO port in a computer system, comprising:
monitoring data access commands directed to the GPIO port; and
upon the identification of a data access command to the GPIO port,
initiating an interrupt in the computer system to place the computer system in interrupt mode;
determining whether the data access command was initiated by an authorized software program;
if the data access command was initiated by an authorized software program, completing the data access command;
if the data access command was initiated by an unauthorized software program, blocking the data access command;
exiting interrupt mode; and
returning control to the software program that initiated the data access command.

2. The method for managing access to a GPIO port in a computer system of claim 1, wherein the monitoring of data access commands is performed at a south bridge of the computer system.

3. The method for managing access to a GPIO port in a computer system of claim 1, wherein the monitoring of data access commands is performed at a north bridge of the computer system.

4. The method for managing access to a GPIO port in a computer system of claim 1, wherein the GPIO port is coupled to an enable pin of a device of the computer system.

5. The method for managing access to a GPIO port in a computer system of claim 4, wherein the GPIO port is coupled to the enable pin of the TPM device of the computer system.

6. The method for managing access to a GPIO port in a computer system of claim 1, wherein the interrupt is a system management interrupt.

7. The method for managing access to a GPIO port in a computer system of claim 1, wherein the step of monitoring of data access commands directed to the GPIO port comprises the step of monitoring write commands directed to the GPIO port.

8. The method for managing access to a GPIO port in a computer system of claim 1, further comprising the step of logging an attempt to access the software device by an unauthorized software program.

9. The method for managing access to a GPIO port in a computer system of claim 1, wherein the step of determining whether the data access command was initiated by an authorized software program comprises the step of analyzing a token associated software program to determine if the software program is authorized to access the GPIO port.

10. The method for managing access to a GPIO port in a computer system of claim 1, wherein the step of determining whether the data access command was initiated by an authorized software program comprises the step of determining whether software program is on a list of approved software programs.

11. A computer system, comprising:
a processor;
a hardware device having an input pin;
a GPIO port coupled to the input pin of the hardware device; and
a bridge device communicatively coupled between the processor and the hardware device, wherein the bridge device is operable to monitor access commands directed to the GPIO port and initiate the execution an interrupt handler in the event that a data access command is directed to the GPIO port, and wherein the interrupt handler blocks the data access command if the data access command is not authorized;

12. The computer system of claim 11, wherein the bridge device is the south bridge of the computer system.

13. The computer system of claim 11, wherein the bridge device is the north bridge of the computer system.

14. The computer system of claim 11, wherein the hardware device is a TPM device.

15. The computer system of claim 14, wherein the input pin of the TPM device is the enable pin of the TPM device.

16. The computer system of claim 11, wherein the interrupt handler complete the data access command if it is determined that the data access command is authorized to access the GPIO port.

17. A method for managing access to a GPIO port that is coupled to an input pin of a device of the computer system, comprising:
identifying write commands directed to the GPIO port;
determining if the write command was initiated by an authorized software program;
if it is determined that the write command was not initiated by an authorized software program, blocking the write command.

18. The method for managing access to a GPIO port that is coupled to an input pin of a device of the computer system of claim 17, further comprising the step of logging each unauthorized write command.

19. The method for managing access to a GPIO port that is coupled to an input pin of a device of the computer system of claim 17, wherein the device of the computer system is a TPM device.

20. The method for managing access to a GPIO port that is coupled to an input pin of a device of the computer system of claim 19, wherein the input pin of the TPM device is the enable pin of the TPM device.
